(19) United States
(12) Patent Application Publication
(10) Pub. No.: US 2026/0002562 A1
(43) Pub. Date: Jan. 1, 2026

(54) CLEVIS

(71) Applicant: Schaeffler Technologies AG & Co. KG, Herzogenaurach (DE)

(72) Inventor: Etienne Calderon, Guanajuato (MX)

(73) Assignee: Schaeffler Technologies AG & Co. KG, Herzogenaurach (DE)

(21) Appl. No.: 18/758,559

(22) Filed: Jun. 28, 2024

(51) Int. Cl. F16C 11/04

(52) U.S. Cl. CPC F16C 11/045

(57) ABSTRACT

A clevis includes: a base that defines a base aperture for receiving a shaft along a base aperture axis; a first arm extending outward from the base, defining a first arm aperture for receiving a shaft along a first arm aperture axis, and defining a first arm central lightening hole between the first arm aperture and the base; and a second arm extending outward from the base, defining a second arm aperture for receiving a shaft along a second arm aperture axis, and defining a second arm central lightening hole between the second arm aperture and the base. The base aperture axis, first arm aperture axis, and second arm aperture axis lie in a first plane, the first and second arm aperture axes are non-perpendicularly angled relative to the base aperture axis, and the first and second arm central lightening holes coincide with the first plane.

### FIELD OF THE DISCLOSURE

The present disclosure generally relates to a clevis. More specifically, the present disclosure relates to a clevis for use in an electric steering actuator.

### BACKGROUND OF THE DISCLOSURE

Clevises have been used in vehicles for attachment to tie rods as well as in other applications.

### SUMMARY OF THE DISCLOSURE

According to a first aspect of the present disclosure, a clevis includes: a base that defines a base aperture for receiving a shaft therethrough along a base aperture axis; a first arm that extends outward from the base, defines a first arm aperture for receiving a shaft therethrough along a first arm aperture axis, and defines a first arm central lightening hole positioned between the first arm aperture and the base; and a second arm that extends outward from the base, defines a second arm aperture for receiving a shaft therethrough along a second arm aperture axis that is coaxial with the first arm aperture axis, and defines a second arm central lightening hole that is positioned between the second arm aperture and the base. The base aperture axis, first arm aperture axis, and second arm aperture axis lie in a first plane, the first and second arm aperture axes are non-perpendicularly angled relative to the base aperture axis, the first arm central lightening hole coincides with the first plane, and the second arm central lightening hole coincides with the first plane.

Embodiments of the first aspect of the disclosure can include any one or a combination of the following features:
the first and second arm aperture axes are non-perpendicularly angled relative to the base aperture axis, such that the first and second arm aperture axes are offset from perpendicular to the base aperture axis by an angle within a range from 3 degrees to 15 degrees;
the first arm central lightening hole is a first distance from the first arm aperture, the second arm central lightening hole is a second distance from the second arm aperture, and the second distance is greater than the first distance;
the first arm central lightening hole is smaller than the second arm central lightening hole;
the second arm aperture is nearer than the first arm aperture to the base aperture;
the first plane defines a first lateral side of the clevis and a second lateral side of the clevis opposite the first lateral side, and the first arm defines a first arm lateral lightening hole disposed on the first lateral side of the clevis and a first arm lateral lightening hole disposed on the second lateral side of the clevis, and the second arm defines a second arm lateral lightening hole disposed on the first lateral side of the clevis and a second arm lateral lightening hole disposed on the second lateral side of the clevis;
the first arm lateral lightening hole disposed on the first lateral side is shaped differently than the second arm lateral lightening hole disposed on the first lateral side;
the first arm lateral lightening holes are partially defined by and positioned laterally outboard of a central support member of the first arm that coincides with the first plane, extends from the first arm aperture to the base, and defines the first arm central lightening hole; and
the second arm lateral lightening holes are partially defined by and positioned laterally outboard of a central support member of the second arm that coincides with the first plane, extends from the second arm aperture to the base, and defines the second arm central lightening hole.

According to a second aspect of the present disclosure, a clevis includes: a base that defines a base aperture for receiving a shaft therethrough along a base aperture axis that lies in a first plane that defines a first lateral side of the clevis and a second lateral side of the clevis opposite the first lateral side; a first arm that extends outward from the base, defines a first arm aperture for receiving a shaft therethrough along a first arm aperture axis that lies in the first plane, and defines a first arm lateral lightening hole disposed on the first lateral side and a first arm lateral lightening hole disposed on the second lateral side, wherein the first arm lateral lightening holes are partially defined by and positioned laterally outboard of a central support member of the first arm that coincides with the first plane; and a second arm that extends outward from the base, defines a second arm aperture for receiving a shaft therethrough along a second arm aperture axis that is coaxial with the first arm aperture axis and that lies in the first plane, and defines a second arm lateral lightening hole disposed on the first lateral side and a second arm lateral lightening hole disposed on the second lateral side, wherein the second arm lateral lightening holes are partially defined by and positioned laterally outboard of a central support member of the second arm that coincides with the first plane.

Embodiments of the second aspect of the disclosure can include any one or a combination of the following features:
the first arm defines a pair of first arm lateral lightening holes disposed on the first lateral side that are partially defined by the central support member of the first arm and a pair of first arm lateral lightening holes disposed on the second lateral side that are partially defined by the central support member of the first arm;
fewer second arm lateral lightening holes that are partially defined by the central support member of the second arm are defined by the second arm than first arm lateral lightening holes that are partially defined by the central support member of the first arm are defined by the first arm;
the central support member of the first arm defines a first arm central lightening hole that coincides with the first plane;
the central support member of the second arm defines a second arm central lightening hole that coincides with the first plane;
the first arm central lightening hole is smaller than the second arm central lightening hole;
the first arm central lightening hole is a first distance from the first arm aperture, the second arm central lightening hole is a second distance from the second arm aperture, and the second distance is greater than the first distance;
the first and second arm aperture axes are non-perpendicularly angled relative to the base aperture axis; and
the first and second arm aperture axes are non-perpendicularly angled relative to the base aperture axis, such that the first and second arm aperture axes are offset from perpendicular to the base aperture axis by an angle within a range from 3 degrees to 15 degrees.

According to a third aspect of the present disclosure, a clevis includes: a base that defines a base aperture for receiving a shaft therethrough; a first arm that extends outward from the base, defines a first arm aperture for receiving a shaft therethrough, and defines a plurality of first arm lightening holes; and a second arm that extends outward from the base, defines a second arm aperture for receiving a shaft therethrough, and defines a plurality of second arm lightening holes, wherein the shape and size of each of the plurality of first arm lightening holes is different than the shape and size of each of the plurality of second arm lightening holes respectively.

Embodiments of the third aspect of the disclosure can include the following feature:
the base defines a plurality of base lightening holes.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of an electric actuator that includes first and second clevises, according to one embodiment;

FIG. 2 is a perspective view of a clevis mounted to an electric actuator via a flanged bolt, according to one embodiment;

FIG. 3 is a perspective view of a clevis that includes a base, a first arm, and a second arm, according to one embodiment;

FIG. 4 is a perspective view of a clevis that is divided into a first lateral side and a second lateral side along a first plane that defines the first and second lateral sides of the clevis, according to one embodiment;

FIG. 5 is an elevational view of a clevis, illustrating a base aperture axis and coaxial first and second arm aperture axes that lie in a first plane and are non-perpendicularly angled relative to the base aperture axis, according to one embodiment;

FIG. 6 is an elevational view of the clevis illustrating first and second planes, according to one embodiment; and

FIG. 7 is a perspective view of a clevis, according to one embodiment.

The components in the figures are not necessarily to scale, emphasis instead being placed upon illustrating the principles described herein.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

For the purposes of this disclosure, a description of axes as coaxial, or as lying in a plane (e.g., first plane), is to be understood to include instances of axes that are close approximations to exactly coaxial axes, or to axes that exactly lie in a plane, unless stated otherwise, reflecting an allowance for tolerances, conversion factors, rounding off, measurement error and the like, and other factors known to those of skill in the art.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

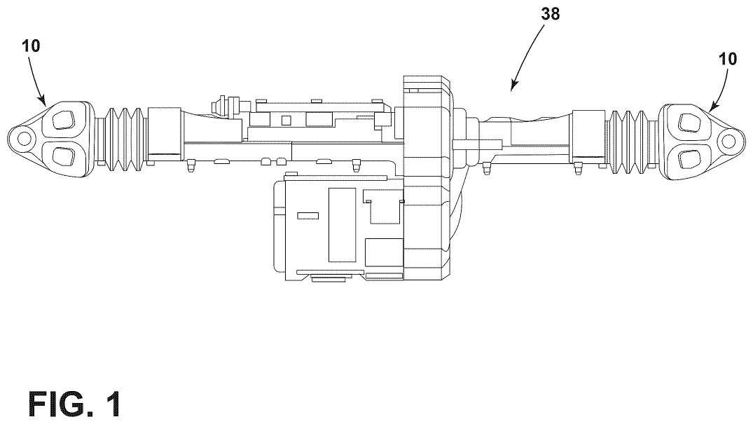

Referring now to FIGS. 1-7, a clevis 10 includes a base 12. The base 12 defines a base aperture 14 for receiving a shaft therethrough along a base aperture axis 18. The clevis 10 includes a first arm 20 that extends outward from the base 12. The first arm 20 defines a first arm aperture 22 for receiving a shaft therethrough along a first arm aperture axis 24. The first arm 20 further defines a first arm central lightening hole 26 positioned between the first arm aperture 22 and the base 12. The clevis 10 includes a second arm 28 that extends outward from the base 12. The second arm 28 defines a second arm aperture 30 for receiving a shaft therethrough along a second arm aperture axis 32 that is coaxial with the first arm aperture axis 24. The second arm 28 further defines a second arm central lightening hole 34 that is positioned between the second arm aperture 30 and the base 12. The base aperture axis 18, first arm aperture axis 24, and second arm aperture axis 32 lie in a first plane 36. The first and second arm aperture axes 24, 32 are non-perpendicularly angled relative to the base aperture axis 18. The first arm central lightening hole 26 coincides with the first plane 36, and the second arm central lightening hole 34 coincides with the first plane 36.

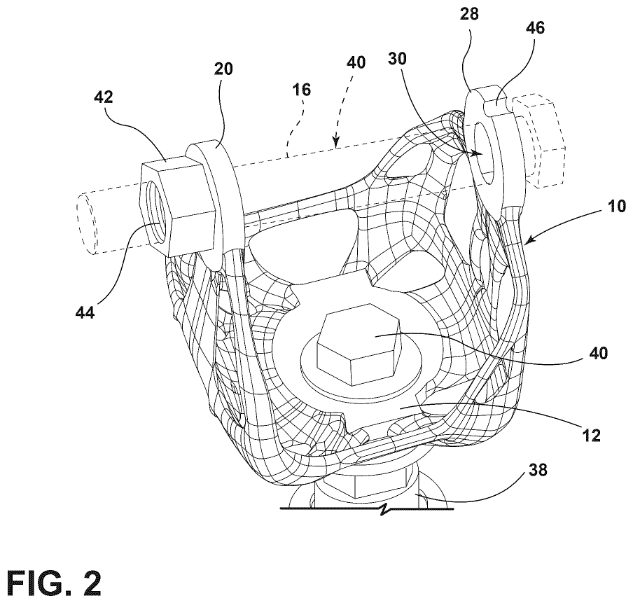

Referring now to FIGS. 1 and 2, an electric steering actuator 38 is illustrated. The electric steering actuator 38 can be mounted to a vehicle (not shown) and can include an electric motor, a gearset, and/or a plurality of additional components. As illustrated in FIG. 1, the electric steering actuator 38 includes a pair of clevises 10 that are disposed at opposite axial ends of the electric steering actuator 38. The clevises 10 may be mounted to the electric steering actuator 38 via a fastener 40, such as a bolt 40. For example, in the embodiment illustrated in FIG. 2, the bolt 40 (shaft of the bolt 40) extends through the base aperture 14 of the clevis 10 to mount the clevis 10 to the electric steering actuator 38. As further illustrated in FIG. 2, a shaft 16 may extend through the first arm aperture 22 and/or the second arm aperture 30 for the purpose of coupling the clevis 10 to another component of the vehicle, such as a tie rod, that is axially distal from the electric steering actuator 38. As illustrated in FIG. 2, a threaded nut 42 is fixed to the first arm 20 of the clevis 10 proximate the first arm aperture 22, such that a hollow 44 defined by the nut 42 and the first arm aperture 22 are aligned with each other. As further illustrated in FIG. 2, the second arm 28 includes a recess 46 that is disposed proximate to the second arm aperture 30. The recess 46 defined by the second arm 28 of the clevis 10 may serve to indicate that the nut 42 should be coupled to the first arm 20 rather than the second arm 28, and/or may serve as an indicator for assembly of the clevis 10 with the tie rod in a poka-yoke fashion.

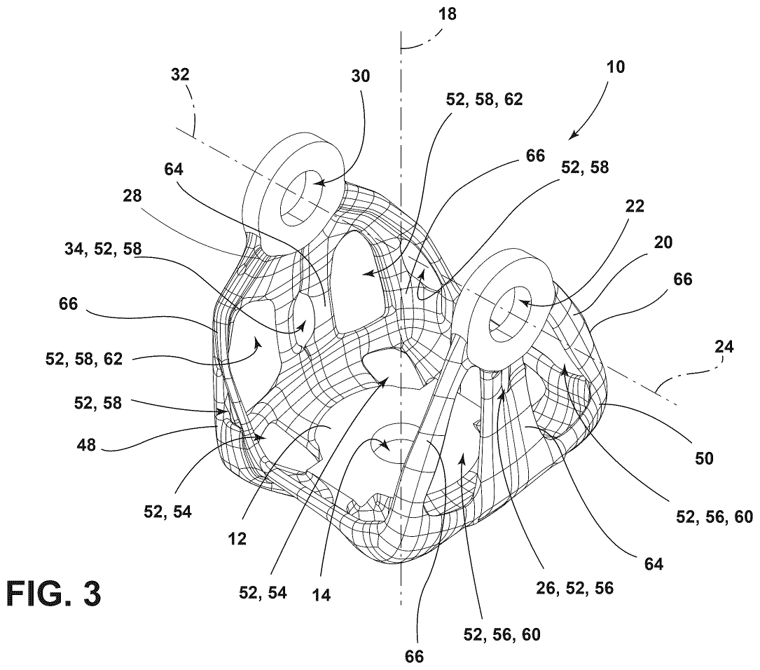

Referring now to FIGS. 3-6, the clevis 10 includes the base 12. The base 12 defines the base aperture 14. As illustrated in FIG. 3, the base aperture axis 18 extends through the base aperture 14. In various implementations, a shaft, such as a bolt shaft, as illustrated in FIG. 2, is configured to extend through the base aperture 14 along the base aperture axis 18.

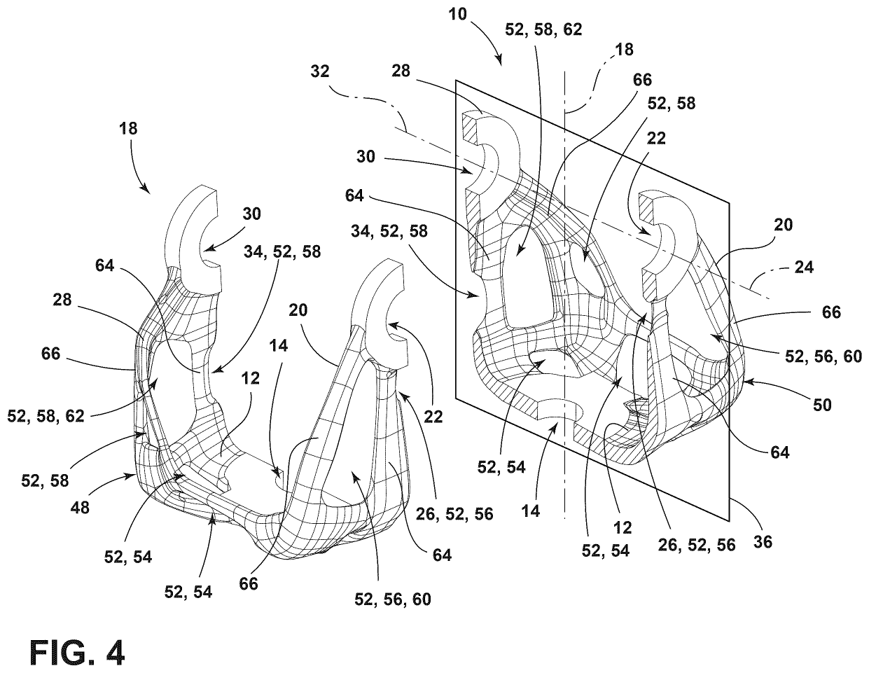

Referring still to FIGS. 3-6, the clevis 10 includes the first arm 20. The first arm 20 extends outward from the base 12. As illustrated in FIG. 3, the first arm 20 defines the first arm aperture 22. The first arm aperture axis 24 extends through the first arm aperture 22. In various implementations, the first arm aperture 22 is configured to receive a shaft 16 therethrough, and the shaft 16 is configured to extend through the first arm aperture 22 along the first arm aperture axis 24. As illustrated in FIG. 4, the first arm aperture axis 24 and the base aperture axis 18 lie in the first plane 36, as described further herein.

Referring still to FIGS. 3-6, the clevis 10 includes the second arm 28 that extends outward from the base 12. The second arm 28 defines the second arm aperture 30. As illustrated in FIG. 3, the second arm aperture axis 32 extends through the second arm aperture 30. As illustrated, the second arm aperture 30 and the first arm aperture 22 are coaxial. The coaxial first and second arm aperture axes 24, 32 and the base aperture axis 18 lie in the first plane 36, in various implementations, as illustrated in FIG. 4. In various embodiments, the second arm aperture 30 is configured to receive a shaft 16 therethrough, and the shaft 16 is configured to extend through the second arm aperture 30 along the second arm aperture axis 32.

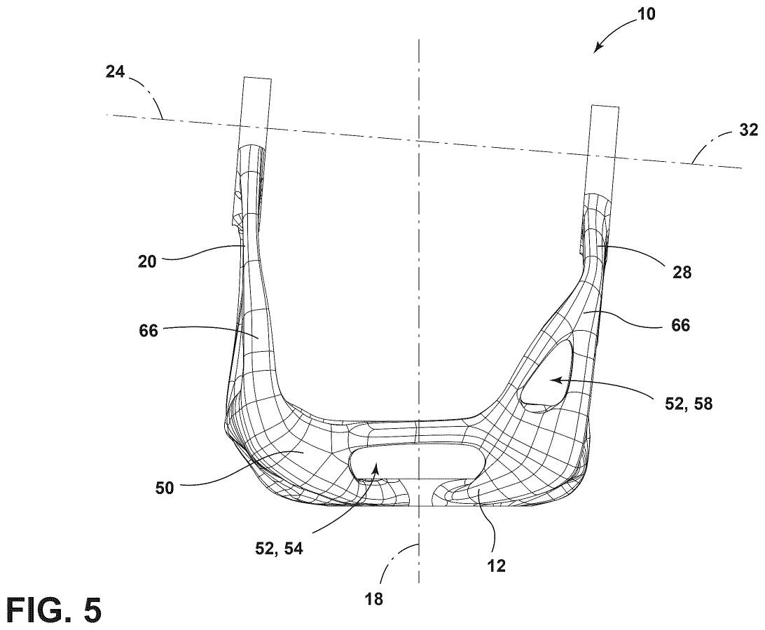

In various implementations, wherein the first and second arm aperture axes 24, 32 are coaxial and lie within the first plane 36 with the base aperture axis 18, the first and second arm aperture axes 24, 32 are non-perpendicularly angled relative to the base aperture axis 18. For example, as illustrated in FIG. 5, the first and second arm aperture axes 24, 32 are non-perpendicularly angled relative to the base aperture axis 18. In the illustrated embodiment, the first and second arm aperture axes 24, 32 are offset from perpendicular to the base aperture axis 18 by an angle of 4.6°. In various embodiments, the first and second arm aperture axes 24, 32 are offset from perpendicular to the base aperture axis 18 by an angle within a range from 3° to 15°. A variety of angles of offset relative to perpendicular are contemplated. In an exemplary implementation of the clevis 10 in the electric steering actuator 38 of a vehicle, the first and second arm aperture axes 24, 32 may be non-perpendicularly angled relative to the base aperture axis 18 to appropriately accommodate attachment of a tie rod to the clevis 10. In various implementations, the second arm aperture 30 is nearer than the first arm aperture 22 to the base aperture 14. The first plane 36 within which the base aperture axis 18, first arm aperture axis 24, and second arm aperture axis 32 may lie may define a first lateral side 48 of the clevis 10 and a second lateral side 50 of the clevis 10 opposite the first lateral side 48 of the clevis 10. For example, as illustrated in FIG. 4, the first plane 36 defines the first and second lateral sides 48, 50 of the clevis 10.

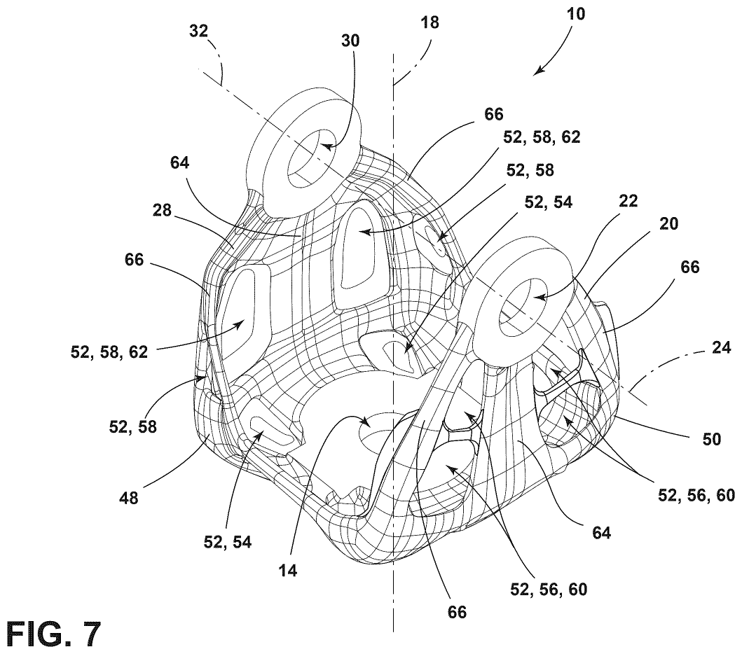

Referring now to FIGS. 3-7, the clevis 10 defines a plurality of lightening holes 52. The lightening holes 52 may be defined by the base 12, first arm 20, and/or the second arm 28 of the clevis 10, as described further herein. In some implementations, the lightening holes 52 may be cut into the clevis 10 via stamping. In some implementations, the clevis 10 may be manufactured via casting, and the lightening holes 52 may be defined as a result of the shape of the mold within which the clevis 10 is cast. The clevis 10 may be formed of metal, in various embodiments. A variety of types of metal and/or other materials are contemplated. In various implementations, the plurality of lightening holes 52 includes one or more base lightening holes 54 that are defined by the base 12, first arm lightening holes 56 that are defined by the first arm 20, and/or second arm lightening holes 58 that are defined by the second arm 28. For example, as illustrated in FIG. 3, the clevis 10 defines a plurality of base lightening holes 54, a plurality of first arm lightening holes 56, and a plurality of second arm lightening holes 58. In various embodiments, the shape and size of the lightening holes 52 varies based on the location of the lightening holes 52 that are defined by the clevis 10. For example, as illustrated in FIGS. 3 and 7, in some embodiments, the first arm 20 defines a plurality of first arm lightening holes 56, the second arm 28 defines a plurality of second arm lightening holes 58, and the shape and size of each of the plurality of first arm lightening holes 56 is different than the shape and size of each of the plurality of second arm lightening holes 58, respectively. The variable shape, size, and position of lightening holes 52 defined by the clevis 10 contributes to the structural integrity of the clevis 10 with regard to stress on the clevis 10 in particular directions, as described further herein.

Referring still to FIGS. 3-7, in various implementations, the first arm 20 defines a first arm lateral lightening hole 60 that is disposed on the first lateral side 48 of the clevis 10 and a first arm lateral lightening hole 60 that is disposed on the second lateral side 50 of the clevis 10. Further, in various implementations, the second arm 28 defines a second arm lateral lightening hole 62 that is disposed on the first lateral side 48 of the clevis 10 and a second arm lateral lightening hole 62 that is disposed on the second lateral side 50 of the clevis 10, as illustrated in FIG. 3. In the illustrated embodiment, the first arm lateral lightening holes 60 are partially defined by and positioned laterally outboard of (i.e., positioned further away from the first plane 36 than) a central support member 64 of the first arm 20. The central support member 64 of the first arm 20 coincides with the first plane 36 and extends between the base 12 and the first arm aperture 22. As further illustrated in FIG. 3, the second arm lateral lightening holes 62 are partially defined by and positioned laterally outboard of a central support member 64 of the second arm 28. This central support member 64 of the second arm 28 coincides with the first plane 36 and extends between the base 12 and the second arm aperture 30.

As illustrated in FIG. 3, in various implementations, the sizes and shapes of the first arm lateral lightening holes 60 are different than the sizes and shapes of the second arm lateral lightening holes 62. In some implementations, the number of lateral lightening holes 52 defined by the first arm 20 is different than the number of lateral lightening holes 52 defined by the second arm 28. For example, as illustrated in FIG. 7, the first arm 20 defines a pair of first arm lateral lightening holes 60 that are disposed on the first lateral side 48 that are partially defined by the central support member 64 of the first arm 20 and a pair of first arm lateral lightening holes 60 disposed on the second lateral side 50 that are partially defined by the central support member 64 of the first arm 20. As illustrated in FIG. 7, the second arm 28 defines fewer second arm lateral lightening holes 62 (two) that are partially defined by the central support member 64 of the second arm 28. As such, fewer second arm lateral lightening holes 62 that are partially defined by the central support member 64 of the second arm 28 are defined by the second arm 28 than first arm lateral lightening holes 60 that are partially defined by the central support member 64 of the first arm 20 are defined by the first arm 20.

Referring still to FIGS. 3-7, in various implementations, the first arm lateral lightening holes 60 can be partially defined by lateral support members 66 of the first arm 20, and the second arm lateral lightening holes 62 can be partially defined by lateral support members 66 of the second arm 28. As illustrated in FIGS. 3 and 7, the first and second arms 20, 28 include lateral support members 66 that extend between the base 12 of the clevis 10 and the first and second arm apertures 22, 30, respectively. In various implementations, at least a portion of the lateral support members 66 of the first and second arms 20, 28 extend laterally outboard (i.e., away from the first plane 36) as the lateral support members 66 extend toward the base 12 of the clevis 10. As such, the laterally outboard peripheries of the first and second arms 20, 28 of the clevis 10 may widen laterally as the peripheries extend toward the base 12. In some implementations, one or more of the lateral support members 66 of the first arm 20 and/or the second arm 28 may define one or more lightening holes 52. For example, as illustrated in FIGS. 3 and 7, the lateral support member 66 of the second arm 28 that is disposed on the first lateral side 48 of the clevis 10 as well as the lateral support member 66 of the second arm 28 that is disposed on the second lateral side 50 of the clevis 10 wholly define respective lightening holes 52.

Referring now to FIGS. 3 and 4, in some embodiments, the first arm 20 defines a first arm central lightening hole 26. The first arm central lightening hole 26 coincides with the first plane 36. In various embodiments, the first arm central lightening hole 26 is defined by the central support member 64 of the first arm 20, as illustrated in FIG. 3. In some embodiments, the second arm 28 of the clevis 10 defines a second arm central lightening hole 34. The second arm central lightening hole 34 coincides with the first plane 36, as illustrated in FIG. 4. In various embodiments, the second arm central lightening hole 34 may be defined by the central support member 64 of the second arm 28. In the embodiment illustrated in FIG. 3, the central support member 64 of the first arm 20 defines the first arm central lightening hole 26 and the central support member 64 of the second arm 28 defines the second arm central lightening hole 34. In some implementations, the first arm central lightening hole 26 is a first distance from the first arm aperture 22, the second arm central lightening hole 34 is a second distance from the second arm aperture 30, and the second distance is greater than the first distance. In some implementations, the first arm central lightening hole 26 is smaller than the second arm central lightening hole 34. For example, in the embodiment illustrated in FIG. 3, the first arm central lightening hole 26 is smaller than the second arm central lightening hole 34, and the first arm central lightening hole 26 is nearer to the first arm aperture 22 than the second arm central lightening hole 34 is to the second arm aperture 30.

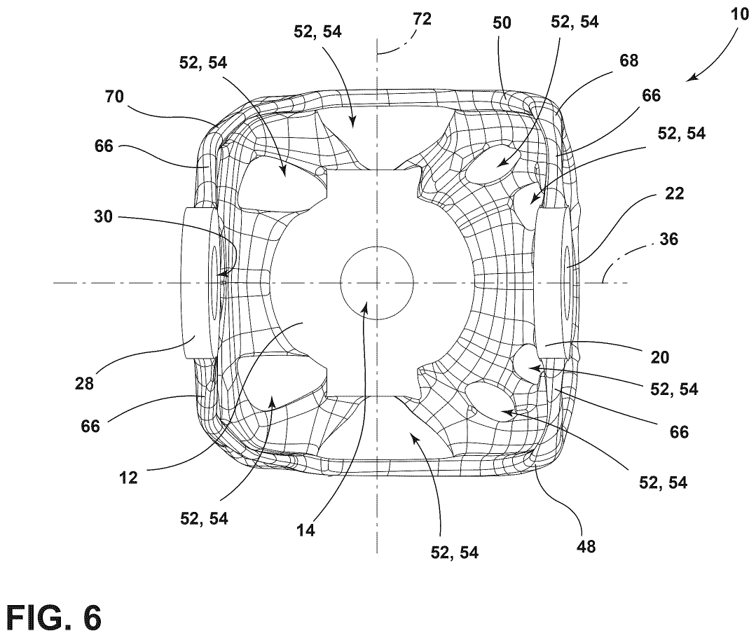

Referring now to FIG. 6, the base 12 of the clevis 10 can include a plurality of base lightening holes 54. As illustrated in FIG. 6, the number and placement of the base lightening holes 54 on the first lateral side 48 of the clevis 10 can be symmetrical to the number and placement of base lightening holes 54 on the second lateral side 50 of the clevis 10. In various implementations, the number, placement, size, and/or shape of the base lightening holes 54 defined by a first longitudinal side 68 of the clevis 10 are not symmetrical to the number, placement, size, and/or shape of the base lightening holes 54 defined on a second longitudinal side 70 of the clevis 10 that is opposite the first longitudinal side 68. As illustrated in FIG. 6, the first and second longitudinal sides 68, 70 are defined by a second plane 72. The second plane 72 extends perpendicular to the first plane 36, and the base aperture axis 18 lies within the second plane 72. As illustrated in FIG. 6, two base lightening holes 54 coincide with the second plane 72, four base lightening holes 54 are defined wholly by the first longitudinal side 68 of the clevis 10, and two base lightening holes 54 are defined wholly by the second longitudinal side 70 of the clevis 10.

The clevis of the present disclosure may provide a variety of advantages. First, the lightening holes 52 may reduce the amount of material necessary to manufacture the clevis 10 and may reduce the weight of the clevis 10 relative to a similar clevis that does not define the lightening holes. Second, the non-uniformity of the lightening holes 52 with regard to position, size, and shape, as described herein, may advantageously bolster the structural integrity of the clevis 10 against application of forces in particular directions. In particular, the non-uniform arrangement of the lightening holes 52 allows the clevis 10 to satisfactorily withstand the forces applied to the clevis 10 in a direction parallel to the base aperture axis 18. The non-uniformity of the lightening holes 52 is optimized to allow the clevis 10 to brace against these axial forces, despite the fact that the first and second arm aperture axes 24, 32 are non-perpendicularly angled relative to the base aperture axis 18 and, therefore, the axial forces applied to the clevis 10.

It is to be understood that variations and modifications can be made on the aforementioned structure without departing from the concepts of the present disclosure, and further it is to be understood that such concepts are intended to be covered by the following claims unless these claims by their language expressly state otherwise.

### LIST OF REFERENCE NUMERALS

10 clevis
12 base
14 base aperture
16 shaft
18 base aperture axis
20 first arm
22 first arm aperture
24 first arm aperture axis
26 first arm central lightening hole
28 second arm
30 second arm aperture
32 second arm aperture axis
34 second arm central lightening hole
36 first plane
38 electric steering actuator
40 fastener
42 threaded nut
44 hollow
46 recess
48 first lateral side
50 second lateral side
52 lightening holes
54 base lightening holes
56 first arm lightening holes
58 second arm lightening holes
60 first arm lateral lightening hole
62 second arm lateral lightening hole
64 central support member
66 lateral support members
68 first longitudinal side
70 second longitudinal side
72 second plane

What is claimed is:

1. A clevis, comprising:
a base that defines a base aperture for receiving a shaft therethrough along a base aperture axis;
a first arm that extends outward from the base, defines a first arm aperture for receiving a shaft therethrough along a first arm aperture axis, and defines a first arm central lightening hole positioned between the first arm aperture and the base; and
a second arm that extends outward from the base, defines a second arm aperture for receiving a shaft therethrough along a second arm aperture axis that is coaxial with the first arm aperture axis, and defines a second arm central lightening hole that is positioned between the second arm aperture and the base, wherein the base aperture axis, first arm aperture axis, and second arm aperture axis lie in a first plane, the first and second arm aperture axes are non-perpendicularly angled relative to the base aperture axis, the first arm central lightening hole coincides with the first plane, and the second arm central lightening hole coincides with the first plane.

2. The clevis of claim 1, wherein the first and second arm aperture axes are non-perpendicularly angled relative to the base aperture axis, such that the first and second arm aperture axes are offset from perpendicular to the base aperture axis by an angle within a range from 3 degrees to 15 degrees.

3. The clevis of claim 1, wherein the first arm central lightening hole is a first distance from the first arm aperture, the second arm central lightening hole is a second distance from the second arm aperture, and the second distance is greater than the first distance.

4. The clevis of claim 3, wherein the first arm central lightening hole is smaller than the second arm central lightening hole.

5. The clevis of claim 4, wherein the second arm aperture is nearer than the first arm aperture to the base aperture.

6. The clevis of claim 1, wherein the first plane defines a first lateral side of the clevis and a second lateral side of the clevis opposite the first lateral side, and wherein the first arm defines a first arm lateral lightening hole disposed on the first lateral side of the clevis and a first arm lateral lightening hole disposed on the second lateral side of the clevis, and the second arm defines a second arm lateral lightening hole disposed on the first lateral side of the clevis and a second arm lateral lightening hole disposed on the second lateral side of the clevis.

7. The clevis of claim 6, wherein the first arm lateral lightening hole disposed on the first lateral side is shaped differently than the second arm lateral lightening hole disposed on the first lateral side.

8. The clevis of claim 6, wherein the first arm lateral lightening holes are partially defined by and positioned laterally outboard of a central support member of the first arm that coincides with the first plane, extends from the first arm aperture to the base, and defines the first arm central lightening hole.

9. The clevis of claim 8, wherein the second arm lateral lightening holes are partially defined by and positioned laterally outboard of a central support member of the second arm that coincides with the first plane, extends from the second arm aperture to the base, and defines the second arm central lightening hole.

10. A clevis, comprising:
a base that defines a base aperture for receiving a shaft therethrough along a base aperture axis that lies in a first plane that defines a first lateral side of the clevis and a second lateral side of the clevis opposite the first lateral side;
a first arm that extends outward from the base, defines a first arm aperture for receiving a shaft therethrough along a first arm aperture axis that lies in the first plane, and defines a first arm lateral lightening hole disposed on the first lateral side and a first arm lateral lightening hole disposed on the second lateral side, wherein the first arm lateral lightening holes are partially defined by and positioned laterally outboard of a central support member of the first arm that coincides with the first plane; and
a second arm that extends outward from the base, defines a second arm aperture for receiving a shaft therethrough along a second arm aperture axis that is coaxial with the first arm aperture axis and that lies in the first plane, and defines a second arm lateral lightening hole disposed on the first lateral side and a second arm lateral lightening hole disposed on the second lateral side, wherein the second arm lateral lightening holes are partially defined by and positioned laterally outboard of a central support member of the second arm that coincides with the first plane.

11. The clevis of claim 10, wherein the first arm defines a pair of first arm lateral lightening holes disposed on the first lateral side that are partially defined by the central support member of the first arm and a pair of first arm lateral lightening holes disposed on the second lateral side that are partially defined by the central support member of the first arm.

12. The clevis of claim 11, wherein fewer second arm lateral lightening holes that are partially defined by the central support member of the second arm are defined by the second arm than first arm lateral lightening holes that are partially defined by the central support member of the first arm are defined by the first arm.

13. The clevis of claim 10, wherein the central support member of the first arm defines a first arm central lightening hole that coincides with the first plane.

14. The clevis of claim 13, wherein the central support member of the second arm defines a second arm central lightening hole that coincides with the first plane.

15. The clevis of claim 14, wherein the first arm central lightening hole is smaller than the second arm central lightening hole.

16. The clevis of claim 15, wherein the first arm central lightening hole is a first distance from the first arm aperture, the second arm central lightening hole is a second distance from the second arm aperture, and the second distance is greater than the first distance.

17. The clevis of claim 10, wherein the first and second arm aperture axes are non-perpendicularly angled relative to the base aperture axis.

18. The clevis of claim 17, wherein the first and second arm aperture axes are non-perpendicularly angled relative to the base aperture axis, such that the first and second arm aperture axes are offset from perpendicular to the base aperture axis by an angle within a range from 3 degrees to 15 degrees.

19. A clevis, comprising:
a base that defines a base aperture for receiving a shaft therethrough;
a first arm that extends outward from the base, defines a first arm aperture for receiving a shaft therethrough, and defines a plurality of first arm lightening holes; and
a second arm that extends outward from the base, defines a second arm aperture for receiving a shaft therethrough, and defines a plurality of second arm lightening holes, wherein the shape and size of each of the plurality of first arm lightening holes is different than the shape and size of each of the plurality of second arm lightening holes respectively.

20. The clevis of claim 19, wherein the base defines a plurality of base lightening holes.
